(19) United States
(12) Patent Application Publication
(10) Pub. No.: US 2003/0189834 A1
(43) Pub. Date: Oct. 9, 2003

(54) Apparatus for attaching light base to light cover and method of making same

(76) Inventor: Cheng Ming Hsing, Kaohsiung (CN)

Correspondence Address: SIDLEY AUSTIN BROWN & WOOD LLP, 717 NORTH HARWOOD, SUITE 3400, DALLAS, TX, 75201, US

(21) Appl. No.: 10/115,811

(22) Filed: Apr. 3, 2002

(51) Int. Cl. F21V 3/00

(52) U.S. Cl. 362/363; 362/454; 362/448

(57) ABSTRACT

A fixture for a light that facilitates the mounting of a cover to a base of the light fixture. The base of the fixture includes at least one frictional spring member, which can lock the cover onto the base. The frictional spring members can provide adequate force to securely lock the cover onto the base of the fixture, yet allow for easy removal and re-installation of the cover onto the base.

### FIELD OF THE INVENTION

The present invention relates to a fixture for a light, and in one aspect, the invention relates to a means for mounting a cover to a base of the fixture.

### BACKGROUND OF THE INVENTION

Light fixtures generally include a base and a shield, and are used to retain an electrical receptacle and an illumination source. Light fixtures serve both a practical and a decorative purpose, as they provide protective hardware in which an electrical receptacle for a light can be mounted, and are available in many different styles.

Conventionally, the shield of the light fixture is mounted in a socket portion of the base of the fixture with screws which are positioned around the periphery of the socket in which the shield is placed. In general, the shield is placed in the socket of the base and each screw around the periphery of the socket is tightened until the force from the plurality of screws against the shield secures the shield in the base.

However, in order to perform routine maintenance on the light fixture, for instance, cleaning, or bulb replacements, the same procedure must be repeated. Specifically, each screw that is used to retain the shield must be loosened in order to release the shield from the socket of the base, and likewise, each screw must be tightened when remounting the shield. This procedure can become cumbersome, as screwdrivers and other hand tools are oftentimes necessary. Further, for instances when the light fixture is located overhead, it becomes especially troublesome to work with the fixture. Moreover, for persons suffering from joint debilitating illnesses where small screws and screw drivers are difficult to grasp, it becomes especially difficult to work with these conventional light fixtures.

### BRIEF SUMMARY OF THE INVENTION

Accordingly, the present invention provides a light fixture that facilitates the removal and mounting of a cover, or shield, from and to a base of the light fixture.

In one aspect of the invention, a fixture for a light comprises a base, and a cover that is positioned on the base, wherein the cover is held against the base by at least one frictional spring member.

In another aspect of the present invention, a fixture for a light comprises a base and at least one frictional spring member provided in the base wherein the at least one frictional member is adapted to secure a cover to the base. Each frictional spring member extends upwardly from the base to a position above an upper surface of the base, extends downwardly and outwardly in a direction away from a center of the base, and extends downwardly and inwardly in a direction toward a center of the base.

In another aspect of the invention, a fixture for a light comprises a base having an upper surface, wherein an interior portion of the upper surface has a recess therein, a cover having a projecting flange and a rim, wherein the projecting flange corresponds to at least a portion of the recess in the upper surface of the base such that the projecting flange can be positioned in the recess, wherein the cover is held against the base by at least one frictional spring member which each extends upwardly from the recess in the upper surface and contacts the rim of the cover to secure the cover to the base.

According to another aspect of the invention, a method of making a fixture for a light comprises the steps of providing a base with at least one orifice therethrough, and positioning a frictional spring member in each the at least one orifice in said base, wherein the frictional spring member extends upwardly from said base and is adapted to secure a cover to the base.

### BRIEF DESCRIPTION OF THE DRAWINGS

Other advantages and features of the invention will become more apparent with reference to the following detailed description of the presently preferred embodiment thereof in connection with the accompanying drawings, wherein like reference numbers have been applied to like elements, in which:

FIG. 1 is a perspective view of a light fixture according to an embodiment of the present invention;

FIG. 2 is a perspective view of a base for the light fixture of FIG. 1;

FIG. 3 is a perspective view of a cover for the light fixture of FIG. 1; and

FIG. 4 is an exploded view of the light fixture of FIG. 1.

### DETAILED DESCRIPTION OF THE INVENTION

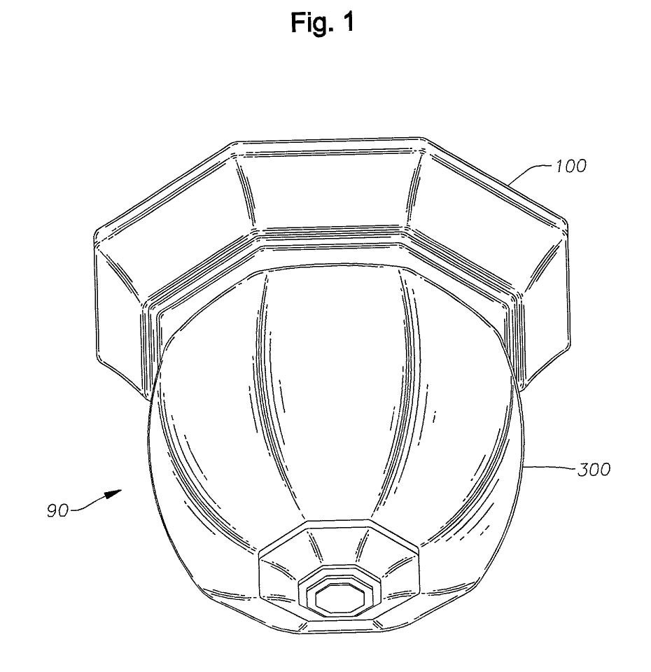

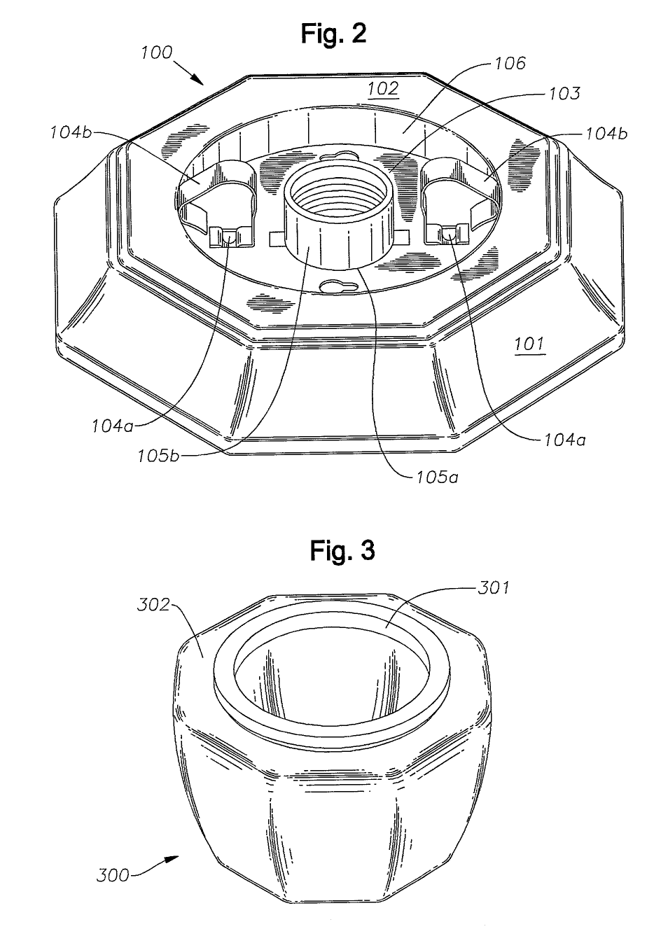

Referring to the drawings, FIG. 1 illustrates a light fixture 90 according to one embodiment of the present invention. According to FIG. 1, light fixture 90 includes a base 100 and a light cover 300, each of which will be described in greater detail with reference to FIGS. 2-4.

Base 100, which is illustrated in greater detail in FIG. 2, is characterized by a side surface 101, an upper surface 102, a recessed portion 103 of upper surface 102, and a wall 106 extending between upper surface 102 and recessed portion 103. According to one embodiment, a portion of side surface 101 forms a plane that is inclined relative to upper surface 102 of base 100. However, base 100 can be of any shape or configuration without departing from the scope of the present invention. Similarly, although the present illustrations depict that recessed portion 103 is bounded by wall 106, which forms a circular perimeter that defines recessed portion 103, the peripheral contour and outline of recessed portion 103 is not limited to any particular shape. For example, the peripheral contour of recessed portion 103 can be formed by linear segments.

According to the embodiment depicted in FIG. 2, base 100 is provided with slots 104a and an opening 105a through the surface of recessed portion 103. Preferably, opening 105a is an orifice in which an electrical receptacle 105b can be positioned, while slots 104a are orifices in which frictional spring members 104b can be positioned.

In a preferred embodiment, opening 105a is provided in a central part of recessed portion 103, as it will serve as a position through which an electrical receptacle 105b can be positioned to power an illumination source. However, the positioning of opening 105a is not limited to any particular position, and can be formed through any portion of base 100. Alternatively, instead of a single opening for an electrical receptacle, a plurality of openings can be formed according to the number of electrical receptacles that will be used. Also, electrical receptacles can be formed integrally into the body of base 100, in which case opening 105a could be omitted from the construction of base 100.

In one embodiment, slots 104a are preferably provided at diametrically opposed positions in recessed portion 103 of upper surface 102. Each slot 104a can be of an appropriate shape and size corresponding to a shape and size of the portion of a frictional spring member 104b that will be inserted into slot 104a. As will be understood by one of ordinary skill in the art, although FIG. 2 illustrates an embodiment where two slots 104a are provided through the surface of base 100, any number of slots can be provided. Also, the positioning of the slots in the surface of base 100 is not limited to the diametrically opposed configuration that is illustrated, slots 104a can be provided at any position in base 100. Further, frictional spring members 104b can be provided in base 100 by any manner including integrally formed into base 100, locked into base 100 with a tab locking assembly, or welded into base 100.

Each frictional spring member 104b is preferably a spring clip. In one embodiment, the shape of frictional spring member 104b generally corresponds to that of a “c”. Accordingly, when frictional spring member 104b is positioned in slot 104a, the frame of frictional spring member 104b extends upwardly from recessed portion 103 to a position above upper surface 102, curves in a direction away from a center of recessed portion 103 and extends downwardly and outwardly toward wall 106, then curves in a direction toward the center of recessed portion 103 and extends downwardly and inwardly in a direction toward the center of recessed portion 103, and away from wall 106. In a preferred embodiment, frictional spring members 104b are formed such that when positioned in slots 104a, at least a portion of each of frictional spring members 104b extends substantially to wall 106.

FIG. 3 is an illustration of cover 300 of FIG. 1, according to one embodiment. As shown, cover 300 has a flange 301 and a rim 302 at an end thereof. In general, flange 301 forms a lip at one end of cover 301, which, as will be explained later, will aid in mounting cover 300 onto base 100. Rim 302 corresponds to a portion of cover 300 that bridges flange 301 to the rest of cover 300, and is generally a flat surface. Although cover 300 is illustrated as an enclosed light shield, any light shield or cover can be used, including partially enclosed light shields.

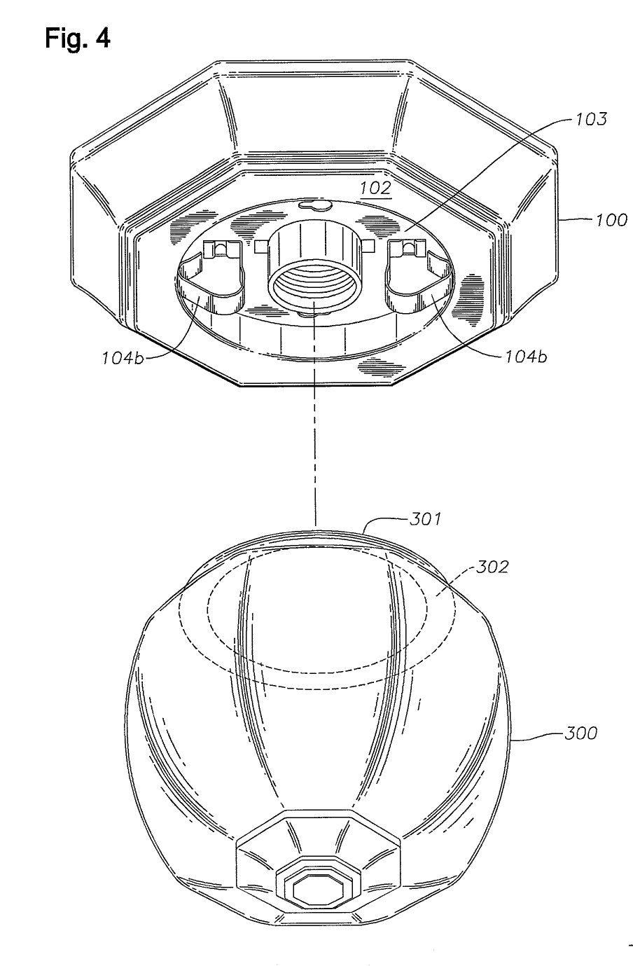

FIG. 4 illustrates an exploded view of FIG. 1. As shown, when cover 300 is being mounted onto base 100, flange 301 of cover 300 will encounter frictional spring members 104b, which project above the surfaces of base 100. Applying a downward force to cover 300 displaces frictional spring members 104b inwardly toward a center of recessed portion 103, as frictional spring members 104b compress due to the force of cover 300 sliding downwardly. Accordingly, as flange 301 continues to slide downwardly over frictional spring members 104b, the surfaces of frictional spring members 104b slide along the inside surface of flange 301 in a compressed state as they continue to deform inwardly, under the downward force of cover 300. Frictional spring members 104b are released from the compressed state as frictional spring members 104b expand onto rim 302 of cover 300 after sliding along the length of the inside surface of flange 301. Flange 301 is thus fully inserted into recessed portion 103 of base 100, and rim 302 of cover 300 is flush against the upper surface 102 of base 100. Thus, a portion of frictional spring members 104b contact rim 302 of cover 300 and hold cover 300 against base 100.

According to the above described method of mounting cover 300 to base 100, frictional spring members 104b are used to secure cover 300 against base 100. More specifically, because the length of flange 301 is sufficient to allow frictional spring members 104b to rest on rim 302 when cover 300 is fully inserted into base 100, frictional spring members 104b are able to apply sufficient force to lock cover 300 onto base 100. Moreover, the force of frictional spring members 104b, which hold cover 300 against base 100 can substantially prevent any rotation of cover 300 on base 100.

In order to remove cover 300 from base 100, it is only necessary to reverse the operation previously described for mounting cover 300 onto base 100. Specifically, by pulling cover 300 away from base 100 in a direction perpendicular to upper surface 102 of base 100, cover 300 slides over frictional spring members 104b in a direction away from base 100 until cover 300 is entirely removed from base 100, and frictional spring members 104b are released back to their original positions. Because it is more likely that base 100 will be mounted onto a surface, base 100 can be held in place and a force perpendicular to, and away from upper surface 102 of base 100 can be applied to cover 300 in order to release cover 300 from frictional spring members 104b.

Although the present invention has been described with reference to a presently preferred embodiment, it will be appreciated by those skilled in the art that various modifications, alternatives, variations, and substitution of parts and elements, may be made without departing from the spirit of the invention. For example, although the above description was made in reference to a light fixture with two frictional spring members, any number of frictional spring members can be used. Further, although the shape illustrated and described with reference to flange 301 and recessed portion 103 is circular, flange 301 and recessed portion 103 can be of any shape. Further, although base 100 has been described with a recessed portion 103 in which flange 301 of cover 300 can be inserted, any base and cover configuration can be used. Thus, the present application is intended to cover such modifications, alternatives, variations and elements as fall within the scope of the appended claims.

What is claimed is:

1. A fixture for a light, said fixture comprising:
a base; and
at least one frictional spring member provided in said base, said at least one frictional spring member adapted to secure a cover to said base.

2. A fixture for a light according to claim 1 wherein said base is capable of being mounted to a surface.

3. A fixture for a light according to claim 1 wherein said at least one frictional spring member extends upwardly from said base to a position above an upper surface of said base, extends downwardly and outwardly in a direction away from a center of said base, and extends downwardly and inwardly in a direction toward said center of said base.

4. A fixture for a light according to claim 1 wherein said base is provided with at least one orifice through said base.

5. A fixture for a light according to claim 4 wherein an electrical receptacle is positioned in said orifice through said base.

6. A fixture for a light according to claim 4 wherein said at least one frictional spring member is positioned in said orifice through said base.

7. A fixture assembly for a light, said fixture assembly comprising:
a base; and
a cover positioned on said base,
wherein said cover is held against said base by at least one frictional spring member.

8. A fixture assembly according to claim 7 wherein said at least one frictional spring member is provided in said base and extends upwardly from said base to a position above an upper surface of said base, extends downwardly and outwardly in a direction away from a center of said base, and extends downwardly and inwardly in a direction toward said center of said base.

9. A fixture assembly for a light according to claim 7 wherein said cover is provided with a rim on which a portion of said frictional spring member rests.

10. A fixture assembly for a light according to claim 7 wherein said base is provided with at least one orifice through said base.

11. A fixture assembly for a light according to claim 10 wherein an electrical receptacle is provided in said at least one orifice through said base.

12. A fixture assembly for a light according to claim 10 wherein said at least one frictional spring member is positioned in said at least one orifice through said base.

13. A fixture assembly for a light, said fixture assembly comprising:
a base having an upper surface, an interior portion of said upper surface having a recess therein;
a cover having a projecting flange and a rim, said projecting flange corresponding to at least a portion of said recess in said upper surface of said base such that said projecting flange can be positioned in said recess,
wherein said cover is held against said base by at least one frictional spring member which each extends upwardly from said recess in said upper surface and contacts said rim of said cover to secure said cover to said base.

14. A fixture assembly for a light according to claim 13 wherein said at least one frictional spring member extends upwardly from said recess in said upper surface of said base to a position above said upper surface of said base, extends downwardly and outwardly in a direction away from a center of said base, and extends downwardly and inwardly in a direction toward said center of said base.

15. A fixture assembly for a light according to claim 13 wherein said projecting flange has a rim surface on which said at least one frictional spring member rests.

16. A method of making a fixture for a light comprising the steps of:
providing a base with at least one orifice therethrough; and
positioning a frictional spring member in said at least one orifice in said base, said frictional spring member extending upwardly from said base and is adapted to secure a cover to said base.
